(19) United States
(12) Patent Application Publication
(10) Pub. No.: US 2005/0207471 A1
(43) Pub. Date: Sep. 22, 2005

(54) Medium detecting device

(75) Inventors: Hiroyuki Matsumoto, Saitama (JP); Takeshi Matsumoto, Saitama (JP); Katsunori Tamamura, Saitama (JP); Takao Yoshida, Saitama (JP); Fumito Inaba, Saitama (JP); Takashi Mizoguchi, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/079,486

(22) Filed: Mar. 15, 2005

(30) Foreign Application Priority Data
Mar. 19, 2004 (JP) 2004-080561

(51) Int. Cl. G01K 11/00

(52) U.S. Cl. 374/161

(57) ABSTRACT

A medium detecting device determines whether a medium is set in a device. The medium detecting device includes an optical sensor irradiates a light towards a position where the medium is possibly set, collects a reflected light, and outputs a signal based on the reflected light. A temperature sensor measures temperature around the optical sensor. A threshold selecting unit selects a threshold from among a plurality of thresholds based on the parameter. A determining unit determines whether the medium is set based on comparison of the signal and the threshold selected.

### BACKGROUND OF THE INVENTION

1. Field of the Invention

The present invention relates to a medium detecting device that detects using an optical sensor whether a medium is set in a device.

2. Description of the Related Art

Noncontact optical sensors that detect objects are used in various fields. Optical sensors are used to detect whether paper money is put in ATMs (automated teller machines), whether coins are inserted in automatic vending machines, whether tickets or commuter passes are inserted in automatic ticket gates, and so forth. In recording medium players, such as CD (compact disc) players or DVD (digital versatile disc) payers, optical sensors are often used to detect whether a CD (compact disc) or a DVD (digital versatile disc) is set in the players.

For example, Japanese Patent Application Laid Open No. 2003-338112 discloses a recording-medium conveying device that includes an optical sensor and microswitches. The optical sensor includes a light emitting diode (LED) and a phototransistor. The optical sensor and the microswitches are used to detect whether the disc is a disc with an outer diameter of 12 centimeters (cm) such as a CD and a DVD, a pseudo disc in which a CD with an outer diameter of 8 cm is fitted in a circular adaptor with an outer diameter of 12 cm, or a CD with an outer diameter of 8 cm.

When a disc is conveyed inside the device with a conveying roller, a medium detecting sensor, which is the optical sensor, detects the disc. The microswitches function as outline detecting sensors that detect the outline of the disc to thereby detecting whether the disc is a 12-cm disc or a 12-cm pseudo disc. During a predetermined masking time period that starts when the disc is detected, if a detection signal output from the medium detecting sensor does not change, then, from the output of the outline detecting sensor it is determined whether the disc is a 12-cm disc or a 12-cm pseudo disc.

According to this conventional technology, a system controller provided with a microprocessor controls the recording-medium conveying device and a recording-medium playback device that includes the recording-medium conveying device. Output of the optical sensor is converted into digital values, and the digital values are binarized into detection signals, based on a predetermined threshold. Specifically, if the output of the optical sensor exceeds the threshold, it is converted to a high logical level (H) detection signal, and if the output is smaller than the threshold, it is converted to a low logical level (L) detection signal. The output of the optical sensor is low when a disc is not set and high when the disc is set. Accordingly, whether a disc is set can be detected using the threshold.

However, output of the optical sensors fluctuates because of fluctuations in power supply and environmental temperature, irregular parts, aging, and so forth. Fluctuations in power supply affect the output as follows. If the power supply increases in the optical sensor, electric current passing through the LED increases and the LED emits a stronger light. As a result, when the phototransistor is turned on, photocurrent increases and corrector voltage decreases, resulting in a smaller value to be output from the optical sensor. On the other hand, if the power supply decreases in the optical sensor, the electric current passing through the LED decreases and the LED emits a weaker light. As a result, when the phototransistor is turned on, the photocurrent decreases and the corrector voltage increases, resulting in a larger value to be output from the optical sensor.

Fluctuations in environmental temperature affect the output as follows. For example, the light emitted from the LED is stronger with lower temperature, and is weaker with higher temperature. On the other hand, sensitivity of the phototransistor decreases with lower temperature (lower photocurrent), and increases with higher temperature (higher photocurrent). When the LED is combined with the phototransistor, the phototransistor has greater influence than the LED. Thus, with higher temperature, the photocurrent increases when the phototransistor is turned on, resulting in a smaller value to be output from the optical sensor. With lower temperature, the photocurrent decreases when the phototransistor is turned on, resulting in a larger value to be output from the optical sensor. This description is applicable when the LED and the phototransistor are used together in the optical sensor. Other types of optical sensors might have different tendencies.

In recent years, highly transmissible C-thru discs have been developed. When a C-thru disc is inserted, the light emitted from the LED is irradiated to the phototransistor. As a result, the output of the optical sensor does not change much, whether the C-thru disc is inserted or not.

FIG. 1 is an example of fluctuations in output of an optical sensor (currents output from the optical sensor). The output fluctuations are assumed to be caused by fluctuations in power supply and environmental temperature, irregular parts, and aging. Transmittance of a C-thru disc is also taken into consideration. A fluctuation range 100 is a range in which the output of the optical sensor fluctuates when the disc is set, and a fluctuation range 120 is a range in which the output of the optical sensor fluctuates when the disc is not set. An operable range 110 is a range in which a threshold to detect the disc is set, located between the fluctuation range 100 and the fluctuation range 120.

A threshold SH1 appropriate under low temperature is applicable for room temperature but with very small margin, and is inapplicable for high temperature. On the other hand, a threshold SH3 appropriate under high temperature is applicable for room temperature but with very small margin, and is inapplicable for low temperature. A threshold SH2 appropriate under room temperature is applicable for high and low temperatures but with very small margins. Failures can increase if the threshold margin is small.

Thus, it is difficult to determine a single threshold with the conventional technology, under the conditions described above.

One approach is to screen out the parts that cause the fluctuation to suppress fluctuations, so that the operable range becomes wider under both high and low temperature conditions, however, this approach leads to increased cost.

### SUMMARY OF THE INVENTION

It is an object of the present invention to at least solve the problems in the conventional technology.

According to an aspect of the present invention, a medium detecting device determines whether a medium is set in a device, and includes an optical sensor that irradiates a light towards a position where the medium is possibly set, collects a reflected light, and outputs a signal based on the reflected light collected; a measuring unit that measures a parameter related to the optical sensor; a threshold selects unit that selects a threshold from among a plurality of thresholds based on the parameter measured; and a determining unit that determines whether the medium is set based on a comparison of the signal and the threshold selected.

According to another aspect of the present invention, a recording-medium playback device determines whether a medium is set using the above medium detecting device.

According to still another aspect of the present invention, a medium detecting method is a method of determining whether a medium is set in a device, and includes irradiating a light from an optical sensor towards a position where the medium is possibly set, collecting at the optical sensor a reflected light, and outputting a signal from the optical sensor based on the reflected light collected; measuring a parameter related to the optical sensor; selecting a threshold from among a plurality of thresholds based on the parameter measured; and determining whether the medium is set based on a comparison of the signal and the threshold selected.

According to still another aspect of the present invention, a computer-readable recording medium stores therein a computer program that causes a computer to implement the above medium detecting method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a relationship between thresholds and fluctuations in output of an optical sensor in a conventional technology;

FIG. 2 is a block diagram of a recording-medium playback device that includes a medium detecting device according to a first embodiment of the present invention;

FIG. 3 is a detailed block diagram of the medium detecting device shown in FIG. 2;

FIG. 4 is an example of a threshold table used in the first embodiment;

FIG. 5 is a relationship between thresholds based on temperature and fluctuations in output of an optical sensor according to the first embodiment of the present invention;

FIG. 6 is a flowchart of an operation of the medium detecting device shown in FIG. 3;

FIG. 7 is a detailed block diagram of a medium detecting device according to a second embodiment of the present invention;

FIG. 8 is an example of a threshold table used in the second embodiment;

FIG. 9 is a relationship between thresholds based on voltage and fluctuations in output of an optical sensor according to the second embodiment of the present invention;

FIG. 10 is an example of a medium detecting device according to a third embodiment of the present invention; and

FIG. 11 is an example of a threshold table used in the third embodiment.

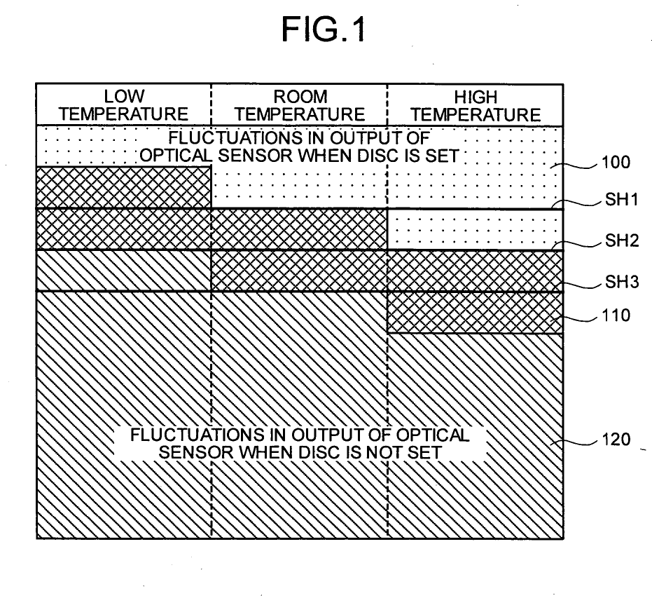

### DETAILED DESCRIPTION

Exemplary embodiments of the present invention will be described below with reference to accompanying drawings.

It is known that output of an optical sensor fluctuates because of various parameters, such as fluctuations in temperature around the optical sensor or in power supply voltage supplied to the optical sensor. In a medium detecting device according to the present invention, a threshold used to detect whether a disc is set in a device, can be variably set according to various parameters.

Specifically, a plurality of thresholds corresponding to various levels of temperature or power supply voltage is predetermined. Immediately before the disc is detected, the temperature or the power supply voltage is measured, and a threshold is selected from among the predetermined thresholds based on the measured temperature or power supply voltage. Accordingly, the output of the optical sensor can be prevented from being affected by the fluctuations in temperature or power supply voltage, so that the disc can be detected accurately.

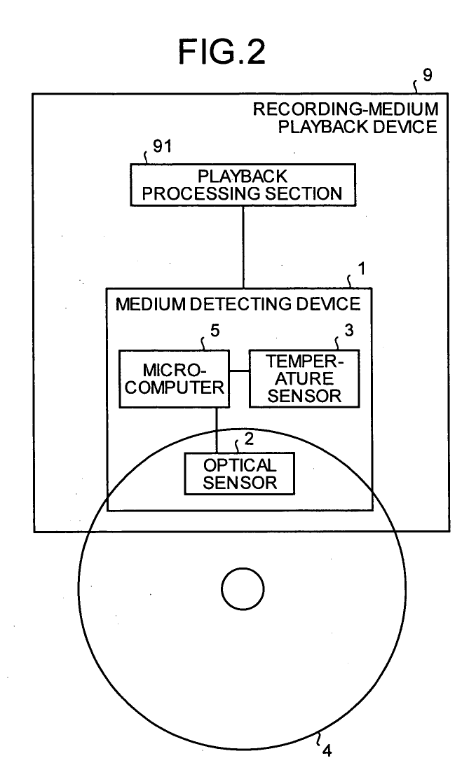

A first embodiment according to the present invention is described with reference to FIGS. 2 to 7. FIG. 2 is a block diagram of a recording-medium playback device 9 according to the first embodiment. The recording-medium playback device 9 includes a medium detecting device 1 and a playback processing section 91. The medium detecting device 1 detects whether a disc 4, which is a recording medium such as a CD or a DVD, is set. After the medium detecting device 1 detects the disc 4, the playback processing section 91 loads the disc 4 to perform playback processing.

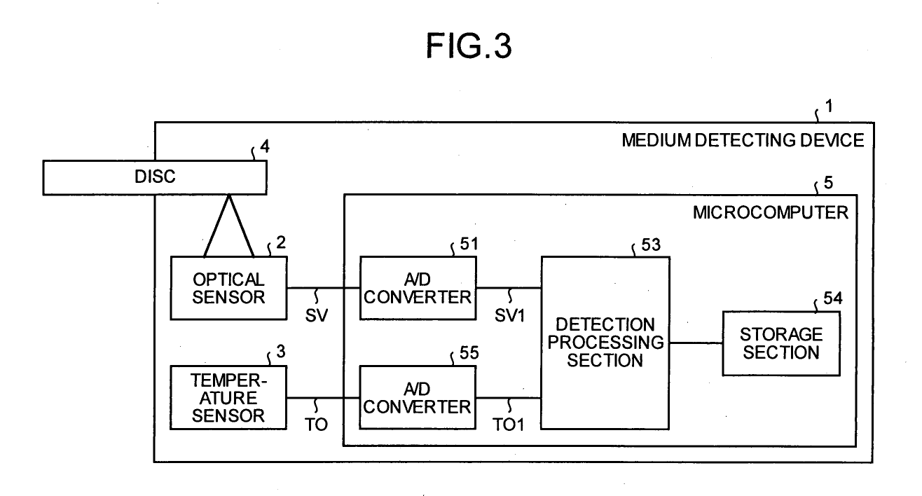

FIG. 3 is a detailed block diagram of the medium detecting device 1 shown in FIG. 2. The medium detecting device 1 includes an optical sensor 2, a temperature sensor 3, and a microcomputer 5.

The optical sensor 2 includes an LED (not shown) and a phototransistor (not shown). Light emitted from the LED controls the phototransistor to turn on/off. The optical sensor 2 outputs a corrector voltage, which is an output of the phototransistor, as an optical sensor output SV, to the microcomputer 5.

The temperature sensor 3 can be a thermistor, a resistance thermometer, a temperature-sensitive ferrite, and so forth. The temperature sensor 3 measures a temperature of or around the optical sensor 2, converts the temperature measured to a voltage, and outputs the voltage as a temperature sensor output TO, to the microcomputer 5.

The microcomputer 5 includes two digital-analogue converters (hereinafter, “A/D converter”) 51, 52, a detection processing section 53, and a storage section 54. The microcomputer 5 executes a computer program stored in a program memory (not shown), to realize a function of the detection processing section 53. The microcomputer 5 monitors the optical sensor output SV and the temperature sensor output TO, to determine whether the disc 4 is set in the medium detecting device 1.

The A/D converter 51 converts the optical sensor output SV into a digital value, and the digital value is output as an optical sensor output SV1 to the detection processing-section 53. The A/D converter 52 converts the temperature sensor output TO into a digital value, and the digital value is output as a temperature sensor output TO1 to the detection processing section 53.

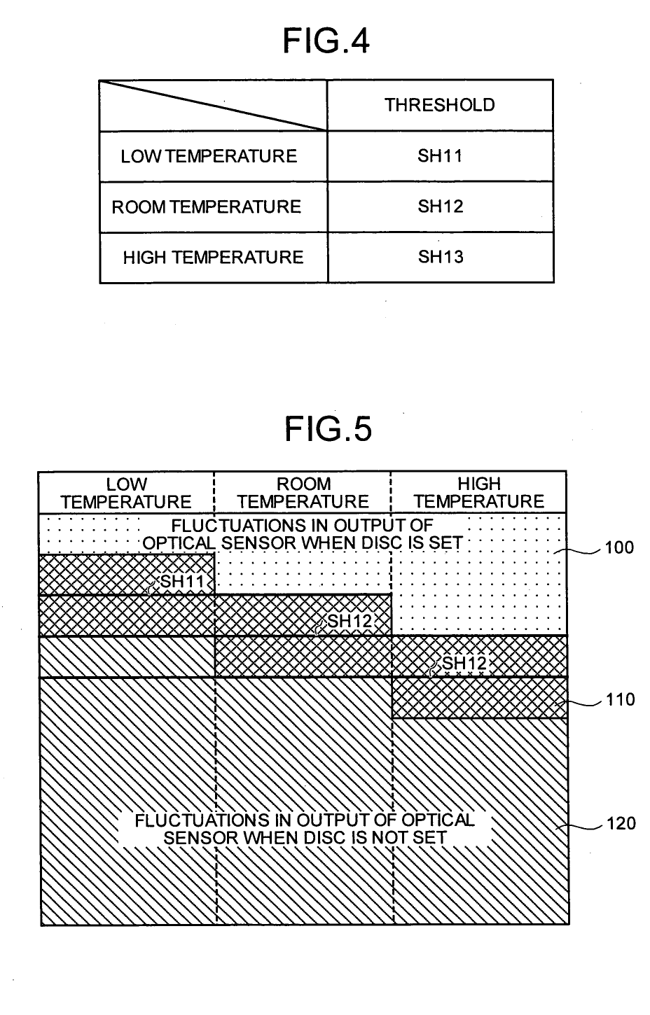

The storage section 54 includes a ROM (read only memory) and a RAM (random access memory), and so forth, and stores a threshold table shown in FIG. 4. The threshold table defines a threshold for each of a plurality of temperatures, such as a threshold SH11 for low temperature, a threshold SH12 for room temperature, and a threshold SH13 for high temperature. These thresholds are determined beforehand based on fluctuations in the optical sensor output SV1, caused by fluctuations in power supply and environmental temperature, irregular parts, aging, and transmittance of a C-thru disc. As shown in FIG. 5, a fluctuation range 100 is a range in which the output of the optical sensor fluctuates when a disc is set. A fluctuation range 120 is a range in which the output of the optical sensor fluctuates when a disc is not set. An appropriate threshold is to be set in an operable range 110, located between the fluctuation range 100 and the fluctuation range 120.

The detection processing section 53 selects a threshold from the threshold table stored in the storage section 54, based on the temperature sensor output TO1. The detection processing section 53 compares the threshold selected with the optical sensor output SV1, to determine whether a disc 4 is set in the medium detecting device 1.

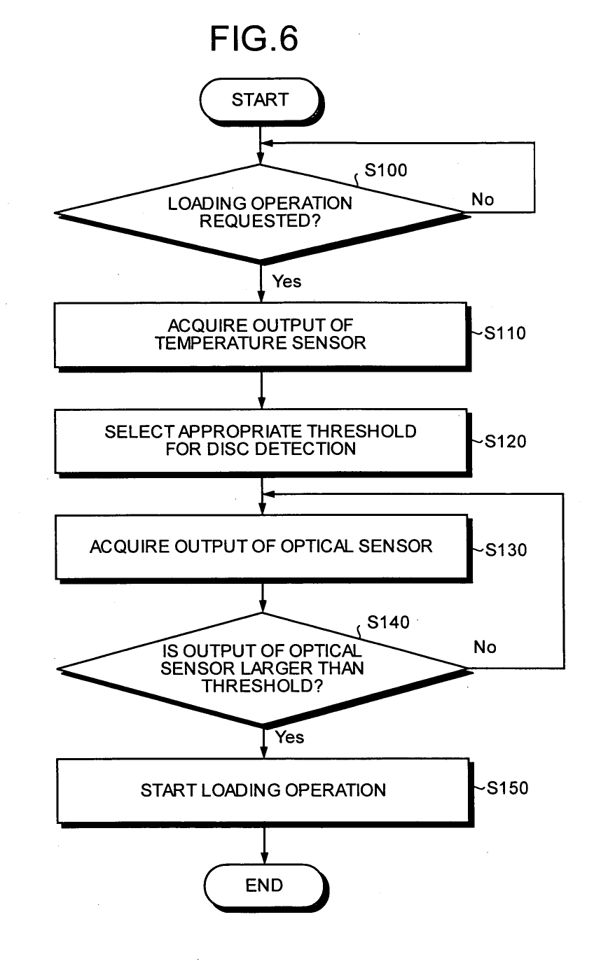

FIG. 6 is a flowchart of an operation performed by the medium detecting device 1. When a loading operation request to insert the disc 4 is received from the playback processing section 91, the detection processing section 53 acquires the temperature sensor output TO1 input from the A/D converter 52 (steps S100 and S110).

The detection processing section 53 selects a threshold from the threshold table stored in the storage section 54, based on the acquired temperature sensor output TO1 (step S120). Specifically, if the temperature sensor output TO1 corresponds to a predetermined low temperature range, the threshold SH11 is selected to detect whether the disc 4 is set. Likewise, thresholds SH12 and SH13 are selected when the temperature sensor output TO1 corresponds to room and high temperature ranges, respectively.

The detection processing section 53 acquires an optical sensor output SV1 of the A/D converter 51 (step S130). The detection processing section 53 compares the optical sensor output SV1 with the threshold selected (step S140). If the optical sensor output SV1 is larger than the threshold, the detection processing section 53 outputs a detection signal that the disc 4 is set.

Upon receiving the detection signal that the disc 4 is set, the playback processing section 91 loads the disc 4 and starts a playback processing (step S150).

The detection processing section 53 repeats the operation of comparing the selected-threshold with an optical sensor output SV1, until the optical sensor output SV1 is larger than the threshold (steps S130 and S140).

As described above, the threshold table is stored in the storage section 54, the temperature sensor 3 measures the temperature before the disc 4 is detected, the detection processing section.53 selects a threshold based on the temperature measured and the threshold table, compares the threshold with the optical sensor output SV1 of the optical sensor 2 to detect whether the disc 4 is set. Therefore, the disc can be detected accurately, without having to screen out parts that cause fluctuations in the output. Moreover, cost is suppressed because the parts do not have to be screened.

In the first embodiment, the medium detecting device 1 includes the temperature sensor 3. However, if the recording-medium playback device 9 already includes a temperature sensor, it can be used. In other words, the temperature sensor 3 does not necessarily have to be provided inside the medium detecting device 1, as long as information that identifies the temperature around the optical sensor 2 is input to the detection processing section 53, such as the temperature sensor output TO or the temperature sensor output TO1.

In the first embodiment, a threshold is selected according to temperature changes. However, fluctuations in output of the optical sensor are not only caused by variations in the temperature, but also caused by variations in the power supply voltage supplied to the optical sensor. In a second embodiment, the threshold is selected according to the power supply voltage.

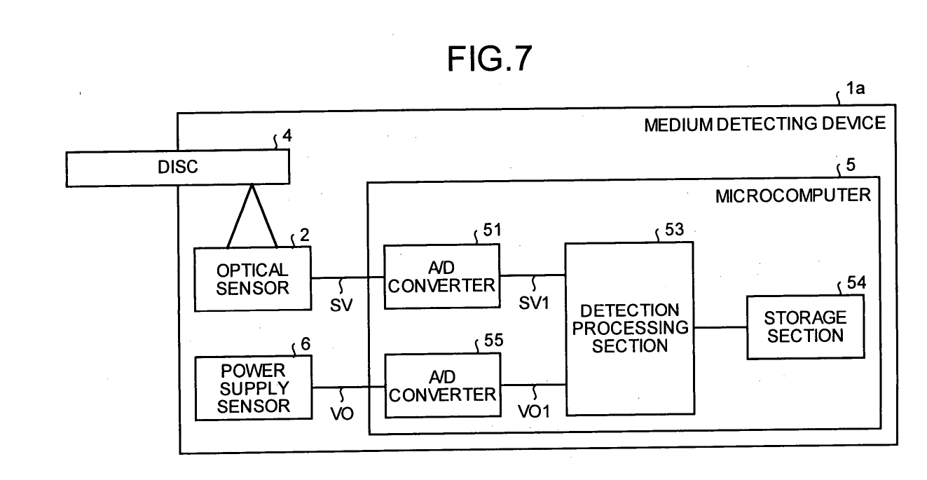

FIG. 7 is a block diagram of a medium detecting device la according to the second embodiment of the present invention. The structure of the medium detecting device la is almost the same as that of the medium detecting device 1 according to the first embodiment shown in FIG. 3, except that a power supply sensor 6 is provided instead of the temperature sensor 3, and an A/D converter 55 is provided instead of the A/D converter 52. Common components are denoted by the same reference numerals and overlapping descriptions are omitted.

The power supply sensor 6 monitors the power supply voltage supplied to the optical sensor 2, and outputs the power supply voltage as a power supply sensor output VO to the A/D converter 55. The A/D converter 55 converts the power supply sensor output VO to a digital value, and the digital value is output as a power supply sensor output VO1 to the detection processing section 53.

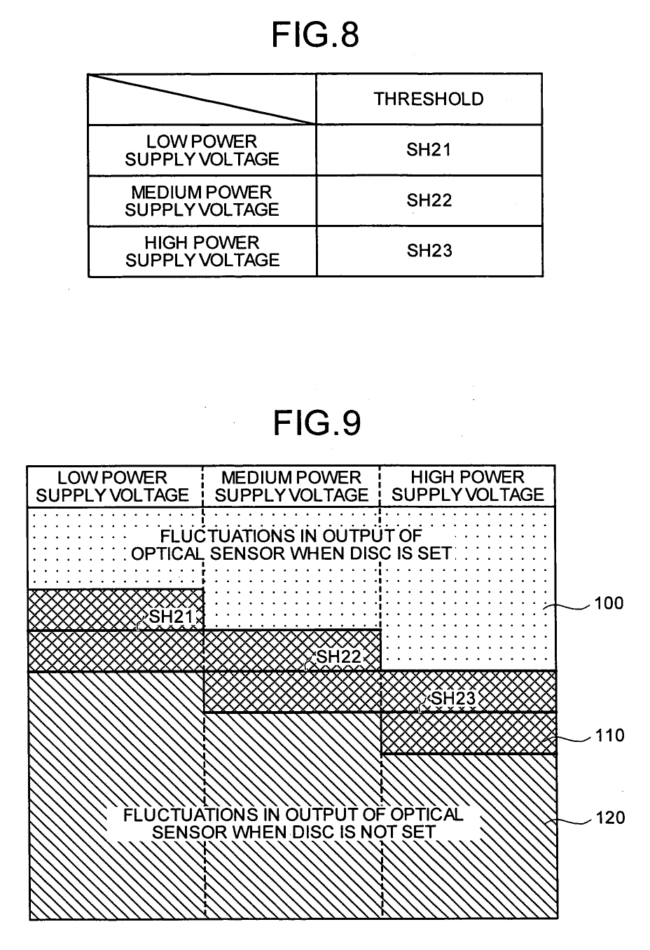

The storage section 54 stores a threshold table that includes a threshold for each of a plurality of levels of the power supply voltage as shown in FIG. 8. For example, a threshold SH21 is for low power supply voltage, a threshold SH22 is for medium power supply voltage, and a threshold SH23 is for high power supply voltage. These thresholds are determined beforehand based on fluctuations in the optical sensor output SV1, caused by fluctuations in power supply and environmental temperature, irregular parts, aging, and transmittance of a C-thru disc. Specifically, an appropriate threshold is to be set in the operable range 110, located between the fluctuation range 100 and the fluctuation range 120, as shown in FIG. 9.

Next, an operation of the medium detecting device la is described. When a loading operation request to insert the disc 4 is received from the playback processing section 91, the detection processing section 53 acquires a power supply sensor output VO1 from the A/D converter 55.

Based on the acquired power supply sensor output VO1 the detection processing section 53 selects a threshold from the threshold table stored in the storage section 54. Specifically, if the power supply sensor output VO1 corresponds to the low power supply range, the detection processing section 53 selects the threshold SH21. Likewise, the detection processing section 53 selects the threshold SH22 when the power supply sensor output VO1 corresponds to the medium power supply range, and selects the threshold SH23 when the power supply sensor output VO1 corresponds to high power supply ranges.

The detection processing section 53 acquires an optical sensor output SV1 from the A/D converter 51. The detection processing section 53 compares the optical sensor output SV1 with the threshold selected. If the optical sensor output SV1 is larger than the threshold, the detection processing section 53 outputs a detection signal that the disc 4 is set.

Upon receiving the detection signal that the disc 4 is set, the playback processing section 91 loads the disc 4 and starts a playback processing. The detection processing section 53 repeats the operation of comparing the selected threshold with an optical sensor output SV1, until the optical sensor output SV1 is larger than the threshold.

As described above, the threshold table is stored in the storage section 54, the power supply sensor 6 measures the power supply voltage before the disc 4 is detected, the detection processing section 53 selects a threshold based on the power supply voltage measured and the threshold table, compares the threshold with the optical sensor output SV1 of the optical sensor 2 to detect whether the disc 4 is set. Therefore, the disc can be detected accurately, without having to screen out parts that cause fluctuations in the output. Moreover, cost is suppressed because the parts do not have to be screened.

In the second embodiment, the medium detecting device 1a includes the power supply sensor 6. However, if the recording-medium playback device 9 already includes a power supply sensor, it can be used. In other words, the power supply sensor 6 does not necessarily have to be provided inside the medium detecting device la, as long as information that identifies,the power supply voltage supplied to the optical sensor 2 is input to the detection processing section 53, such as the power supply sensor output VO or the or the power supply sensor output VO1.

The parameters used to select the threshold in the first and second embodiments are temperature and power supply voltage, respectively. However, any other parameter that affects the output of the optical sensor can be used. Moreover, a plurality of parameters can be used in combination.

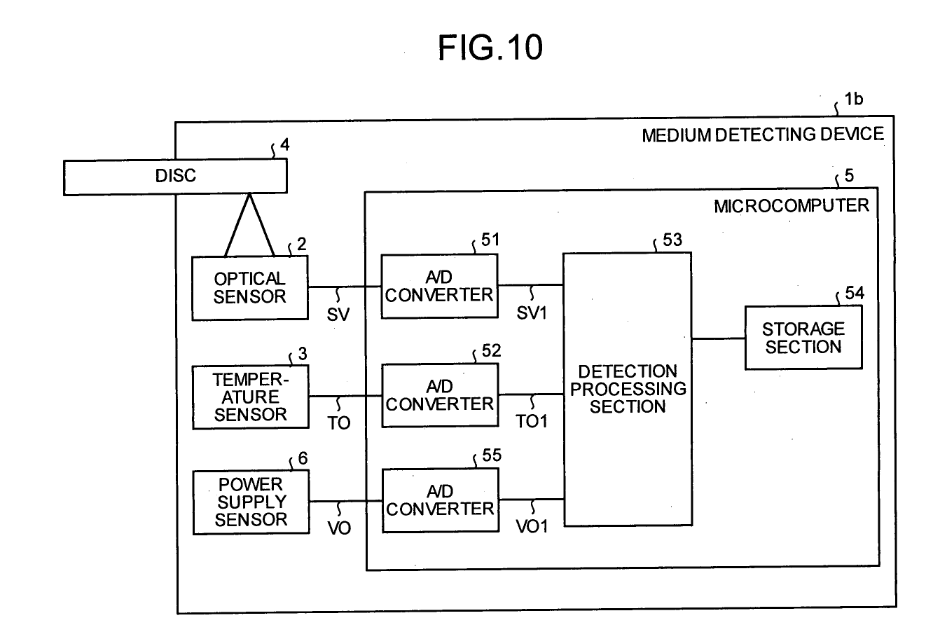

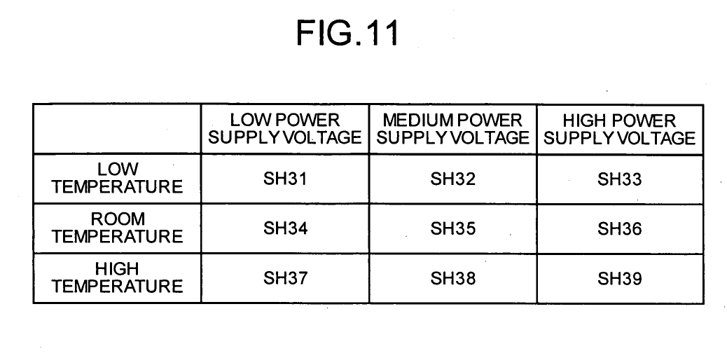

An example shown in FIG. 10 is a combination of FIG. 3 and FIG. 7, i.e., both the temperature sensor 3 and the power supply sensor 6 are included. Thus, the threshold table stored in the storage section 54 defines thresholds for each of a plurality of combinations of the temperature and the power supply voltage, as shown in FIG. 11. For example, a threshold SH31 is for low temperature and low power supply voltage, a threshold SH32 is for low temperature and medium power supply voltage, a threshold SH33 is for low temperature and high power supply voltage, a threshold SH34 is for room temperature and low power supply voltage, a threshold SH35 is for room temperature and medium power supply voltage, a threshold SH36 is for room temperature and high power supply voltage, a threshold SH37 is for high temperature and low power supply voltage, a threshold SH38 is for high temperature and medium power supply voltage, and a threshold SH39 is for high temperature and high power supply voltage.

When a loading operation request to insert the disc 4 is received, the detection processing section 53 acquires a temperature sensor output TO1 from the A/D converter 52 and a power supply sensor output VO1 from the A/D converter 55, selects a threshold from the threshold table based on the temperature sensor output TO1 and the power supply sensor output VO1, compares the optical sensor output SV1 with the threshold selected. The threshold can be set more accurately using both the temperature and the power supply voltage as compared to the case when only one parameter is used.

In the first and second embodiments, the medium detecting device 1 is used to detect whether the disc 4 is set in the recording-medium, playback device 9 that plays back discs such as DVDs and CDs. However, the medium detecting device 1 can be used to detect any medium in any device.

According to the present invention, a disc can be detected accurately, and cost can be suppressed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A medium detecting device that determines whether a medium is set in a device, comprising:
an optical sensor that irradiates a light towards a position where the medium is possibly set, collects a reflected light, and outputs a signal based on the reflected light collected;
a measuring unit that measures a parameter related to the optical sensor;
a threshold selects unit that selects a threshold from among a plurality of thresholds based on the parameter measured; and
a determining unit that determines whether the medium is set based on a comparison of the signal and the threshold selected.

2. The medium detecting device according to claim 1, further comprising:
a storage unit that stores a correspondence of various levels of the parameter and the thresholds, wherein
the threshold selecting unit selects a threshold from the storage unit based on a level of the parameter measured.

3. The medium detecting device according to claim 1, wherein the parameter is temperature, and the measuring unit is a temperature sensor that measures a temperature of or around the optical sensor.

4. The medium detecting device according to claim 1, wherein the parameter is voltage, and the measuring unit is a voltage sensor that measures a voltage supplied to the optical sensor.

5. The medium detecting device according to claim 1, wherein the parameter includes temperature and voltage, wherein the measuring unit includes a temperature sensor that measures a temperature of or around the optical sensor, and an voltage sensor that measures a voltage supplied to the optical sensor.

6. A recording-medium playback device that loads a medium when the medium is set and plays back the medium, comprising:
a medium detecting device that determines whether the medium is set, wherein the medium detecting device includes
an optical sensor that irradiates a light towards a position where the medium is possibly set, collects a reflected light, and outputs a signal based on the reflected light collected;
a measuring unit that measures a parameter related to the optical sensor;
a threshold selects unit that selects a threshold from among a plurality of thresholds based on the parameter measured; and
a determining unit that determines whether the medium is set based on a comparison of the signal and the threshold selected.

7. A medium detecting method of determining whether a medium is set in a device, comprising:
irradiating a light from an optical sensor towards a position where the medium is possibly set, collecting at the optical sensor a reflected light, and outputting a signal from the optical sensor based on the reflected light collected;
measuring a parameter related to the optical sensor;
selecting a threshold from among a plurality of thresholds based on the parameter measured; and
determining whether the medium is set based on a comparison of the signal and the threshold selected.

8. The medium detecting method according to claim 7, further comprising:
storing a correspondence of various levels of the parameter and the thresholds in a storing unit, wherein
the selecting includes selecting a threshold from the storage unit based on a level of the parameter measured.

9. The medium detecting method according to claim 7, wherein the parameter is temperature, and the measuring includes measuring a temperature of or around the optical sensor.

10. The medium detecting method according to claim 7, wherein the parameter is voltage, and the measuring includes measuring a voltage supplied to the optical sensor.

11. The medium detecting method according to claim 7, wherein the parameter includes temperature and voltage, wherein the measuring includes measuring a temperature of or around the optical sensor and measuring a voltage supplied to the optical sensor.

12. A computer-readable recording medium that stores therein a computer program that causes a computer to determine whether a medium is set in a device, wherein the computer program causes the computer to execute:
irradiating a light from an optical sensor towards a position where the medium is possibly set, collecting at the optical sensor a reflected light, and outputting a signal from the optical sensor based on the reflected light collected;
measuring a parameter related to the optical sensor;
selecting a threshold from among a plurality of thresholds based on the parameter measured; and
determining whether the medium is set based on comparison of the signal and the threshold selected.
